(19) United States
(12) Patent Application Publication
(10) Pub. No.: US 2014/0147555 A1
(43) Pub. Date: May 29, 2014

(54) EDIBLE COMPOSITIONS

(71) Applicant: ELWHA LLC, Bellevue, WA (US)

(72) Inventors: Maxime J. J. Bilet, Seattle, WA (US); Ilya Fushman, (US); Roderick A. Hyde, Redmond, WA (US); Jordin T. Kare, Seattle, WA (US); Vinod Khosla, (US); David Mann, (US); Nathan P. Myhrvold, Medina, WA (US); Tony S. Pan, Cambridge, MA (US); Clarence T. Tegreene, Mercer Island, WA (US); Lowell L. Wood, JR., Bellevue, WA (US); Christopher C. Young, Seattle, WA (US)

(73) Assignee: Elwha LLC, Bellevue, WA (US)

(21) Appl. No.: 13/686,721

(22) Filed: Nov. 27, 2012

(51) Int. Cl. A23L 1/00

(52) U.S. Cl. CPC A23L 1/0047
USPC 426/72; 426/103; 426/89

(57) ABSTRACT

The present technology provides an edible composition including a plurality of dietary strands coated with a flavored coating; where the interior of each dietary strand comprises a fat, protein, carbohydrate, or a combination thereof; where the dietary strands are braided or woven together; and where the flavor of the interior of the dietary strand is distinct from the flavor of the flavored coating. Also provided are methods of providing an animal with nourishment, including providing the animal with any one of the edible compositions described herein. The animal may or may not be a human.

### BACKGROUND

Many foods such as candy, although virtually devoid of nutrition, are eagerly consumed because they taste good. Alternatively, some foods or edible substances are nutritious yet generally shunned by consumers because they taste bland or worse. As the global population grows so does the collective challenge of feeding and nourishing so many people. To do so, it will be helpful to more efficiently utilize an increasing range of edible and nutritious feedstocks, including bland and bad tasting substances, by making them more enticing to eat.

The flavoring of foods is not new. It has been suggested that medieval eaters occasionally seasoned their food, such as spoiled meat, to disguise an unsavory taste or odor. Such methods of masking the flavor of spoiled foods are still used where nutritious foods are scarce. Currently needed, however, are more sophisticated food processing technologies that imbue nutritious foods, with pleasant flavors or odors. Such processing technologies might encourage people to consume, and enable them to be nourished by, pleasantly flavored foods that they might not otherwise eat. Such processing technologies might also produce foods with extended shelf lives that will conveniently be stored and delivered to populations that lack local access to nutritious food.

### SUMMARY

According to one exemplary embodiment, the present technology provides an edible composition including a plurality of dietary strands coated with a flavored coating; where the interior of each dietary strand includes a fat, protein, carbohydrate, or a combination thereof; where the dietary strands are braided or woven together; and where the flavor of the interior of the dietary strand is distinct from the flavor of the flavored coating. The edible compositions described herein are designed to taste, smell, and/or have textures that taste, smell, and/or feel, upon eating, like conventional foods, such as meat.

According to another exemplary embodiment, the present technology presents a method of providing an animal with nourishment, including providing the animal with any one of the edible compositions described herein. In some embodiments, the animal is a human. In other embodiments, the animal is not a human.

The foregoing is a summary and thus by necessity contains simplifications, generalizations and omissions of detail. Consequently, those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

The skilled artisan will understand that the drawings primarily are for illustrative purposes and are not intended to limit the scope of the inventive subject matter described herein.

FIGS. 1A-1D illustrate, in accordance with one embodiment, representative two-dimensional space-filling patterns that can be adopted by the dietary strands or the braids of dietary strands.

FIG. 2 illustrates, in accordance with one embodiment, representative three-dimensional weave patterns that can be adopted by the dietary strands or the braids of dietary strands.

FIG. 3A-3D illustrate, in accordance with one embodiment, representative dietary strand structures and representative braided strand structures.

FIGS. 4A-4C illustrate, in accordance with one embodiment, representative dietary granules. Such dietary granules can be added to the dietary strands to augment textures.

FIG. 5A-5B illustrate, in accordance with one embodiment, representative three-dimensional space-filling patterns and one such conventional food that can be made from dietary strands or the braids and weaves of dietary strands.

### DETAILED DESCRIPTION

The illustrative embodiments described in the detailed description, drawings, and claims are not meant to be limiting. Other embodiments may be utilized, and other changes may be made, without departing from the spirit or scope of the subject matter presented here.

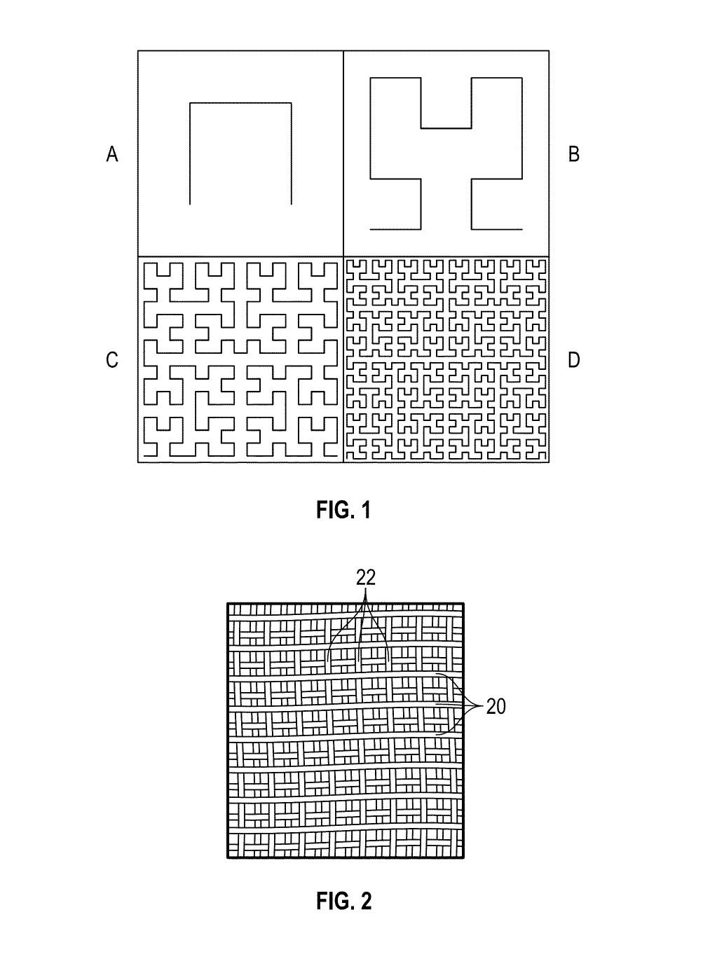

Referring to FIGS. 1A-1D, in accordance with one embodiment, illustrations are provided of representative two-dimensional space-filling patterns that can be adopted by dietary strands or braids of dietary strands. Dietary strands or braids of dietary strands can adopt space-filling Peano curve patterns of FIGS. 1A-1D, for example, to impart different textures to the edible compositions described herein. The space-filling Peano curve of FIG. 1A is less densely packed than that shown in FIG. 1B, which is less densely packed than that shown in FIG. 1C, which is less densely packed than that shown in FIG. 1D. Thus, by adopting the space-filling Peano curve of FIG. 1A, dietary strands or braids of dietary strands can mimic food textures that are relatively light and airy. By adopting the space-filling Peano curve of FIG. 1D, dietary strands or braids of dietary strands can mimic conventional food textures that are relatively dense and heavy.

Referring to FIG. 2, in accordance with one embodiment, an illustration is provided of a representative two-dimensional weave pattern that dietary strands or braids of dietary strands can adopt. The longitudinal dietary strands or braids 22 are called the warp strands and the lateral dietary strands or braids of dietary strands 20 are the weft strands.

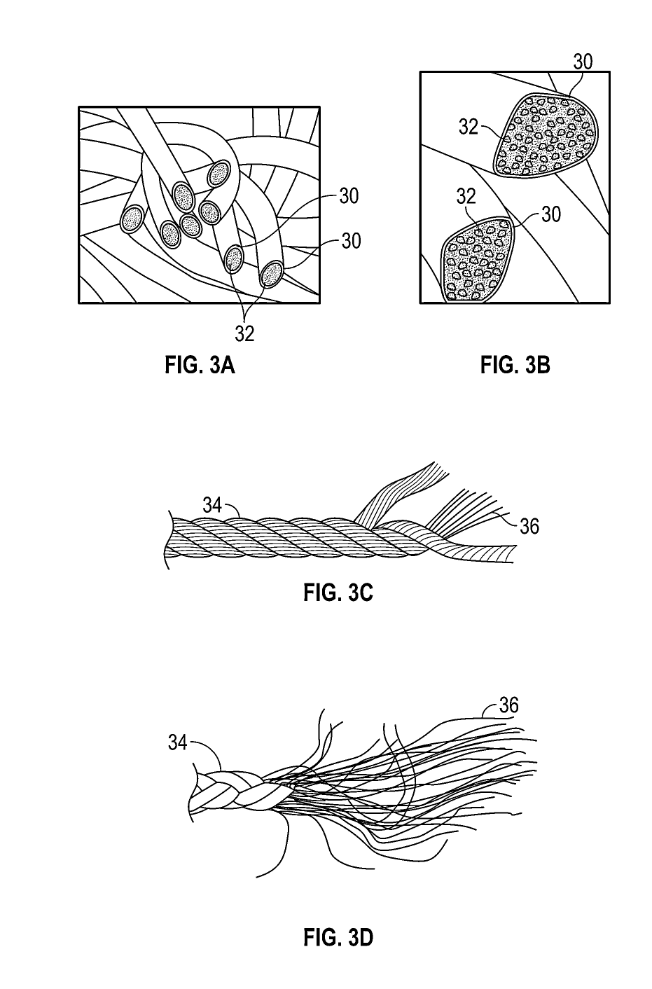

Referring to FIGS. 3A-3D, in accordance with one embodiment, illustrations are provided of representative structures that the dietary strands and braids can adopt. FIG. 3A illustrates a cross section of the dietary strands, including exteriors 30 and interiors 32, and illustrates how they might aggregate. FIG. 3B illustrates the thickness of the flavored coating relative to the dietary strand. FIG. 3B also illustrates that the interior of dietary strands 32 can be an airy structure. FIG. 3C illustrates how the individual dietary strands 36 can be wound into braids 34. FIG. 3D illustrates the effect of chewing upon the braids. Note that chewing has “unwound” the braids 34 into individual dietary strands 36. However, chewing has not substantially damaged the individual dietary strands themselves.

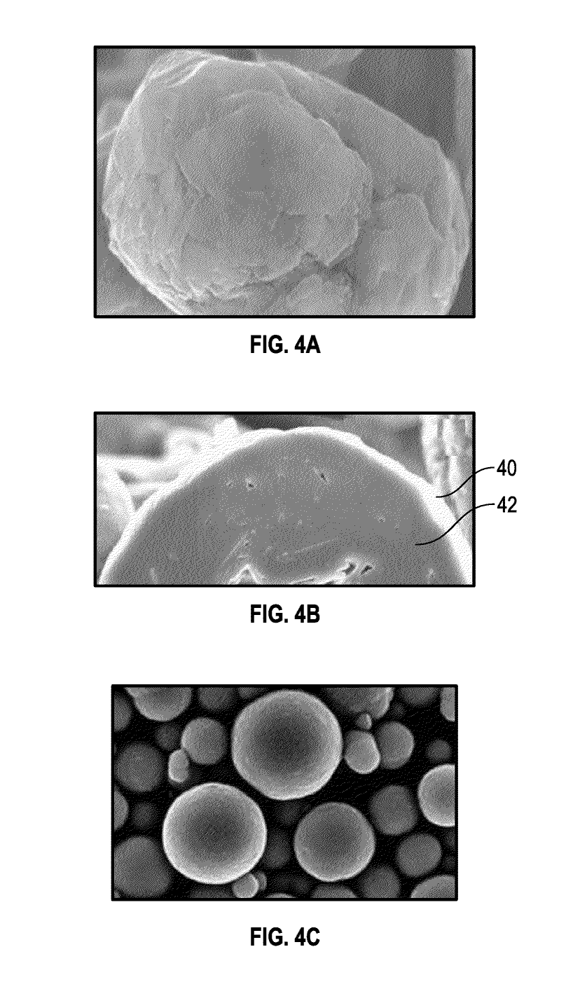

Referring to FIGS. 4A-4C, in accordance with one embodiment, illustrations are provided of representative dietary granules. Such dietary granules of edible compositions can be added to the dietary strands to augment textures. FIG. 4A illustrates the flavored coating at the exterior of a dietary strand. FIG. 4B illustrates a cross section of a dietary granule and the thickness of the flavored coating 40 of the granule relative to the interior region 42 of the dietary granule. FIG. 4C illustrates how dietary granules adhere together.

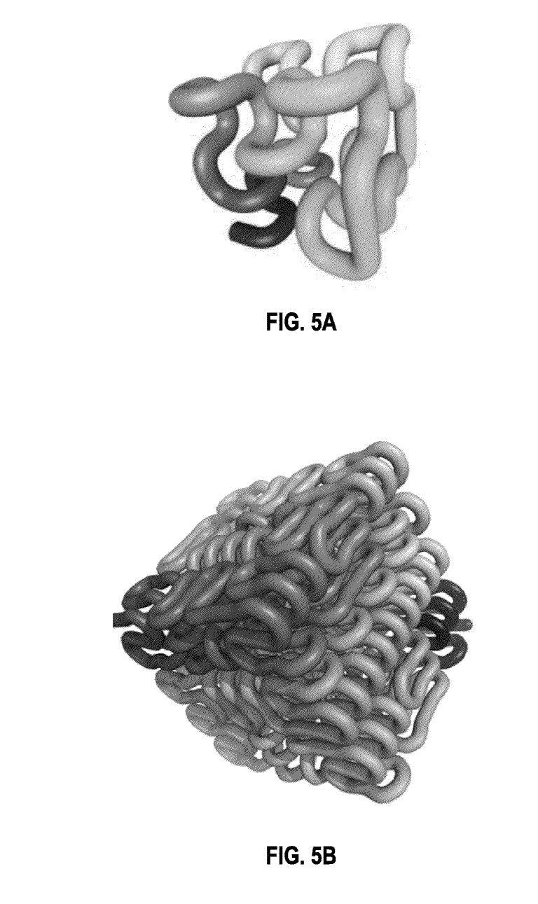

Referring to FIGS. 5A-5B, in accordance with one embodiment, illustrations are provided of representative three-dimensional space-filling patterns and food items that dietary strands or braids of dietary strands can adopt. FIG. 5A illustrates three-dimensional space-filling patterns that dietary strands or braids of dietary strands can adopt, for example, to impart different textures to the edible compositions described herein. Dietary strands or braids of dietary strands can adopt three-dimensional space-filling Peano curve patterns of FIGS. 5A and 5B, where the space-filling Peano curve of FIG. 5A is less densely packed than that shown in FIG. 5B. By adopting the space-filling Peano curve of FIG. 5A, dietary strands or braids of dietary strands can mimic food textures that are relatively light and airy. By adopting the space-filling Peano curve of FIG. 5B, dietary strands or braids of dietary strands can mimic food textures that are relatively dense and heavy.

The technology is described herein using several definitions, as set forth throughout the specification.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

As used herein, “meat” refers to animal flesh that is eaten as food. Meat includes the skeletal muscle and associated fat and other tissues. As used herein, meat includes the flesh of mammalian species (pigs, cattle, lambs, etc.) raised and prepared for human consumption, in addition to fish and other seafood, poultry, and other animals.

As used herein, “processing” refers to any physical and chemical methods used to obtain the edible compositions described herein and includes, but is not limited to, heat conditioning, flaking and grinding, extrusion, solvent extraction, or aqueous soaking.

As used herein, “extrusion” refers to processes whereby the edible compositions or dietary strands are passed through a jacketed auger using high pressures and/or temperatures as a means of extruding the dietary strands into strands.

As used herein, “texturing” and “structuring” refer to modifications in the extrusion processes used to modify the physical characteristics of the extruded dietary strand. The characteristics of these processes, have been described previously in U.S. Pat. No. 3,488,770, and in New Protein Foods, ed. by Altschul and Wilcke, Academic Press, Vol. 1A, Chapter 8, pp 367-414. Moreover, conditions used during extrusion processing of complex foodstuff mixtures that include soy protein products have been described previously by Rokey et al., (1983) Feed Manufacturing Technology III, 222-237; and in U.S. Pat. No. 4,454,804.

As used herein, the phrase “conventional food” means any food that is typically eaten by an animal, such as human, pet, livestock, or wild animal. Thus, conventional foods include human foods, pet foods, and animal feed.

The present technology relates generally to edible compositions that include “dietary strands.” The interior of these dietary strands carry a dietary payload but generally lacks an appealing flavor. To make these dietary strands and edible compositions palatable, the dietary strands are coated with a flavored coating. Upon consumption of the edible composition, the consumer tastes the flavored coating and is spared from the flavor of the dietary strands, or any lack of flavor therein, while becoming nourished by the dietary payload of these edible compositions. This effect is produced, in part, because these coated dietary strands and edible compositions substantially prevent the flavor of the dietary strand, or its lack of flavor, from contacting the taste buds of the consumer and diminishing the eating experience. These edible compositions can be used to make substances such as soy-based protein or edible forms of cellulose more palatable to consumers. The use of braiding or weaving to join an assemblage of dietary strands together, as opposed to using a binding agent, can be advantageous both in maximizing the proportion of the edible composition occupied by the dietary payload and in utilizing the structural and patterning properties of braids or weaves (e.g., as developed for the textile industry).

Not only are these edible compositions designed to taste and smell like conventional foods, they are further designed to feel like conventional foods, such as meat. Authentic food-like textures are achieved, in part, from the three-dimensional arrangements of the dietary strands and from “braids” or “weaves” of such dietary strands. For example, the coated dietary strands can be wound together into more substantial braids or laced up into more substantial weaves of the strands. The individual strands and the resulting braids or weaves of dietary strands can be arranged into three-dimensional shapes and/or supporting scaffolds that are used to mimic the three-dimensional texture of conventional food.

According to one aspect, the present technology provides an edible composition including a plurality of dietary strands coated with a flavored coating; where the interior of each dietary strands includes a fat, protein, carbohydrate, or a combination thereof; where the dietary strands are braided or woven together; and where the flavor of the interior of the dietary strand is distinct from the flavor of the flavored coating.

The edible compositions described herein are designed to taste and smell like conventional foods. Most foods are chewed, swallowed, and ingested without the majority of the volume of the food being tasted. Only a small fraction of the food that is ingested by an animal, such as a human, actually contacts the taste buds and excites taste receptors. Thus, the majority of flavorings in food are consumed and ingested without ever being tasted. Conversely, the edible compositions described herein are designed to selectively provide the flavor of the flavored coating to the taste buds of the animal and substantially prevent the flavor of the dietary strands from contacting the taste buds of the animal. Rather, the dietary payload of the dietary strands is delivered directly to the stomach.

The edible compositions described herein are further designed to have textures that feel, upon eating, like conventional foods. In some embodiments, the edible compositions described herein mimic the texture of a conventional food, such a meat. For example, the edible compositions described herein have arrangements of dietary strands with variable strength, stiffness, and/or three-dimensional space-filling patterns. Such arrangements can be used to mimic the texture of conventional foods such as meat, cheese, or breads such as pizza crust.

Conventionally coated foods taste like their outer coating until the coated food is chewed and crushed to expose the interior of the coated food to the taste buds. For example, when initially placed in one's mouth, an M&M® candy (Mars, Inc. McLean, Va.) tastes like its outer sugar coating because just the outer coating is initially in contact with taste buds. However, upon chewing the M&M® candy is crushed. The crushed M&M® then tastes like chocolate because the chocolate interior of the crushed M&M® is thereby placed into contact with taste buds.

Unlike conventionally coated foods, such as an M&M® candy, the edible compositions described herein, and the coated dietary strands in particular, taste like their flavored coatings when initially placed in one's mouth and continue to taste like the flavored coatings, rather than the dietary strands, as the edible compositions are chewed, crushed, and ingested. This is so, in part, because the dietary strands are generally too small to become substantially crushed when chewed. Rather, upon chewing, the edible composition is compressed and crushed, but the individual dietary strands within the edible composition merely separate, dislodge, “unbraid,” or “unweave” from one another. Chewing the edible compositions separates dietary strands and continually exposes their flavored coatings to taste buds without substantially breaking open the dietary strands and exposing their interior region to taste buds. As such, the flavored coatings, rather than the interior of the dietary strands, maintain contact with the taste buds while the edible compositions are chewed and ingested. Thus, in some embodiments, the size scale of the diameter of the dietary strands is smaller than that which is compressed and disintegrated by gnashing teeth upon chewing. However, the dietary strands are eventually chemically disintegrated during digestion, releasing their dietary payload, upon exposure to gastric fluids in the stomach. In some embodiments, the dietary strands are segmented into a plurality of discrete longitudinal segments interconnected by linkages into a longer composite strand. The linkages can themselves be coated dietary strands, or they can be edible strands having different configurations (e.g., they may have a uniform composition). The linkages can be designed to dissipate during the eating process (e.g., by chewing forces, or by dissolution in gastric fluids) so as to separate the dietary strands into their longitudinal segments, thereby improving the user's chewing or swallowing experience. The individual longitudinal segments can have large length to diameter aspect ratios (e.g., 3:1, 10:1, 20:1, 50:1, 100:1, or greater) so as to minimize the taste effect of their ends. The mass or taste effects of the linkages can be reduced by minimizing their length relative to that of the longitudinal segments (e.g., less than 1%, 2%, 5%, 10%, 20%).

The present technology provides edible compositions having dietary strands that are made from an edible, though not necessarily flavorful, substances (e.g., cellulose, tofu, whey, etc.) The dietary strands dominate the volume of the edible compositions described herein and provide the consumer with some dietary benefit (i.e., dietary payload) such as carbohydrates, calories, protein, and/or fat, etc. These dietary strands may be supplemented with vitamins or nutrients. The dietary strands may have an appealing flavor or odor, but generally the dietary strands are bland tasting and have little apparent odor.

The dietary strands, having their beneficial dietary payload, are optionally coated with a relatively thin flavored coating. The purpose of this thin flavored coating is to impart an appealing taste or smell to the surface of the coated dietary strands, which are then combined, adhered together, braided, or woven into larger forms (i.e., the edible compositions) that have tastes and smells that resemble conventional foods, such as meat. In some embodiments, the edible compositions described herein mimic the flavor and aroma of flavorful foods by coating a thin layer of flavoring onto the surface of an edible composition. The thin layer of flavoring contacts taste buds and mimics the flavor of a “target” conventional food.

In some embodiments, the edible composition includes a single type of dietary strand. In some embodiments, the edible composition includes more than one type of dietary strand. As used herein, the term “type of dietary strand” refers to the particular formulation of a dietary strand (i.e., the particular composition and formulation of its dietary payload). For example, one type of dietary strand may include a particular percentage of soy protein and another percentage of vitamins or minerals. A second type of dietary strand may include a different percentage of whey protein and have no vitamins or minerals. In some embodiments, the edible composition includes more than one type of dietary strand. For example, the edible composition may include 2, 5, 10, 20, 50, 100 or 1,000 types of dietary strands, or a range between and including any two of these values.

In some embodiments, the edible composition further includes dietary granules, where the dietary granules are structurally similar to the dietary strands except for their granular shape, and where the dietary granules are coated with a flavored coating. Such dietary granules of edible compositions can be added to the dietary strands to augment the textures of the edible compositions.

As noted, the edible compositions include dietary strands having a dietary payload that may include any edible substance. The dietary payloads within dietary strands generally utilize an agent or substance that is intended for human or animal consumption. In some embodiments, the dietary strands have a flavor that is bland or unappealing to a human or animal relative to the flavor of the flavored coatings. In some embodiments, dietary payloads include an agent or substance considered to be “food grade” by the Food Chemicals Codex (FCC). In other embodiments, “food grade” refers to an agent or substance classified by the United States Food and Drug Administration (US FDA) as generally regarded as safe (GRAS) and/or classified as food additive, and/or allowed for use on food products and food contact surfaces as those terms are defined by the United States Food and Drug Administration in the Code of Federal Regulations, Chapter 21, Parts 178, 184, and 186. In further embodiments, “food grade” refers to an agent or substance that is a “feed material” or “food additive” as these terms are defined by the European Union. Food materials are defined, for example, by Regulations (EC) Nos 1831/2003, 767/2009, and 575/2011 of the European Parliament and of the Council. Food additives are defined, for example, by European Parliament and Council Directive 95/26 EC.

In some embodiments, the dietary strands include a protein, carbohydrate, lipid, or a combination thereof.

The edible composition may include proteins that derive from any source of edible protein, such as animal, vegetable, dairy products, or a combination thereof, including soy, whey, or tofu. Examples of suitable vegetable protein sources are soybeans, safflower seed, corn, peanuts, wheat, peas, sunflower seed, cottonseed, coconut, rapeseed, sesame seed, leaf proteins, single cell proteins such as yeast, and the like. Thus, for example, if the protein source is soybeans, the soybeans may be dehulled and solvent extracted, preferably with hexane, to remove the oil therefrom. The resulting oil-free soybean meal is then suspended in water, and alkali is added to dissolve the protein and leave behind undissolved carbohydrates. Thereafter the protein is precipitated from the alkaline solution by the addition of an acidic substance. Precipitated protein is then washed and dried to prepare a substantially pure protein isolate. Conditions typically used to prepare soy protein concentrates have been described by U.S. Pat. No. 3,897,574 and Campbell et al, (1985) in New Protein Foods, ed. by Altschul and Wilcke, Academic Press, Vol. 5, Chapter 10, Seed Storage Proteins, pp 302-338. Similar methods can be utilized with regard to other cereal sources of protein.

The edible composition may include any or all three of the major groups of soy protein products. These groups are based on protein content, and range from 40% to over 90%. They are: soy flours and grits, soy protein concentrates and soy protein isolates. The edible composition may include other soy products derived from the processing of soybeans, such as soy fiber. Additionally, the dietary strands may include any tofu product made by coagulating soybean milk and pressing the resulting curds.

Additionally, the dietary strands may include protein from animal protein sources, such as those derived from milk, poultry, meat, and/or fish. A typical example of a suitable animal protein is egg albumin. Additionally, the dietary strands may include any whey product derived from the processing of whey, the liquid material created as a by-product of cheese production. In some embodiments, the dietary strands include a mixture of globular proteins isolated from whey.

Additionally, the dietary strands may include protein that is heat-coagulable (e.g., casein) or any other edible protein. In some embodiments, the protein is water-hydratable protein that facilitates the absorption of water.

The dietary strands will include an amount of protein that can and will vary. For example, the dietary strands may include about 1%, 5%, 10%, 20%, 30%, 40%, 50%, 60%, 70%, 80%, 90%, 100%, or a range between and including any two of these values, by weight of edible protein.

While excellent dietary strands can be formed where the protein mix includes 100% of an edible protein, less protein may yield more palatable food, such as imitation meats. For example, generally less than 80% by weight of an edible protein will yield palatable imitation meats; the remaining portion including other ingredients as described herein.

As noted, in some embodiments, the dietary strands include a carbohydrate. Representative carbohydrates include sugars (glucose, fructose, galactose, sucrose, lactose, etc.) starches, cellulose and the like. Cellulose is made from wood pulp and cotton, and is the primary ingredient in cardboard. However, edible forms of cellulose may be used, such as those described in U.S. Pat. No. 6,936,291.

The dietary strands will include an amount of carbohydrates that can and will vary. For example, the dietary strands may include about 1%, 5%, 10%, 20%, 30%, 40%, 50%, 60%, 70%, 80%, 90%, 100%, or a range between and including any two of these values, by weight of carbohydrates.

As noted, in some embodiments, the dietary strands include fats and lipids. Examples of fats and lipids include, but are not limited to, saturated and unsaturated fatty acids and/or glycerides derived from animal, vegetable, or marine fats and oils, including synthetically prepared shortenings. These glycerides can contain saturated or unsaturated “long chain” acyl radicals having from about 12 to about 22 carbon atoms such as lauroyl, lauroleoyl, myristoyl, myristoleoyl, palmitoyl, palmitoleoyl, stearoyl, oleoyl, linoleoyl, linolenoyl, arachidoyl, arachidonyl, behenoyl, erucoyl, and the like, and are generally obtained from edible fats and oils such as cottonseed oil, soybean oil, coconut oil, rapeseed oil, peanut oil, olive oil, palm oil, palm kernel oil, sunflower seed oil, rice bran oil, corn oil, sesame seed oil, safflower oil, wallflower oil, nasturtium seed oil, whale oil, sardine oil, herring oil, menhaden oil, pilchard oil, lard, tallow and the like.

The type of fat that is added to the dietary strands can be selected to best mimic any particular food. For instance, a vegetable fat such as cottonseed oil may be incorporated into the dietary strands when an unsaturated fat is desired to prepare simulated meat containing no animal products. Alternatively, animal fats may be incorporated into the dietary strands to achieve fat levels that replicate those found in various meats. Other ingredients such as flavoring agents, coloring, seasoning, and the like can also be added to the fat composition to simulate any particular food, such as a meat product.

The dietary strands will include an amount of fats and lipids that can and will vary. For example, the dietary strands may include about 1%, 5%, 10%, 20%, 30%, 40%, 50%, 60%, 70%, 80%, 90%, 100%, or a range between and including any two of these values, by weight of fats and lipids.

In some embodiments, the dietary strands further include one or more vitamins and/or minerals. Representative vitamins include, but are not limited to, the group of fat soluble vitamins consisting of retinol (vitamin A), calciferol (vitamin D), tocopherol (vitamin E), phytomenadione (vitamin K1), water soluble vitamins group consisting of thiamine (vitamin B1), riboflavin (vitamin B2), pyridoxine (vitamin B6), nicotinamide (niacin), pantothenic acid, biotin, folic acid, cyanocobalamin (vitamin B12), ascorbic acid (vitamin C), polyunsaturated fatty acids (PUFA), and the like.

Representative minerals include, but are not limited to, salts of sodium, potassium, magnesium, calcium, chloride, phosphate, iron, copper, zinc, manganese, cobalt, vanadium, chromium, selenium, molybdenum, nickel, boron, silica, silicon, fluorine, iodine, arsenic and the like.

The dietary strands will include an amount of one or more vitamins and/or minerals that can and will vary. For example, the dietary strands may include about 1%, 5%, 10%, 20%, 30%, 40%, 50%, or a range between and including any two of these values, by weight of one or more vitamins and/or minerals.

In some embodiments, the dietary strands further include one or more anti-caking agents and/or humectants. Representative anti-caking agents include, but are not limited to, sodium, potassium, calcium hexacyanoferrate (II), calcium silicate, magnesium silicate, tricalcium phosphate, magnesium carbonate and the like. Representative humectants include, but are not limited to, 1,2-propanediol, glycerol, manitol, sorbitol and the like.

The dietary strands will include an amount of anti-caking agents and/or humectants that can and will vary. For example, the dietary strands may include about 1%, 5%, 10%, 20%, 30%, 40%, 50%, or a range between and including any two of these values, by weight of the anti-caking agents and/or humectants.

In some embodiments, the diameter of each individual dietary strand coated with a flavored coating is in the range of about 1 μm to about 1 cm. In some embodiments, the diameter of the dietary strand coated with a flavored coating is about 1 μm, 10 μm, 100 μm, 1 mm, 10 mm, 100 cm, 1 cm, or a range between and including any two of these values. In some embodiments each individual dietary strand is a granule. In other embodiments each individual dietary strand is a strand.

In some embodiments, individual dietary strands are wrapped into braids. For example, the diameter of each braid of the numerous dietary strands, where each individual dietary strand is first coated with a flavored coating before braiding, is in the range of about 1 μm to about 1 cm. In some embodiments, the diameter of each braid of the numerous dietary strands, where the individual dietary strands are first braided, and the resulting braid is then coated with a flavored coating after braiding, is about 1 μm, 10 μm, 100 μm, 1 mm, 10 mm, 100 cm, 1 cm, or a range between and including any two of these values.

In some embodiments, the dietary strands are substantially insoluble in saliva. In some embodiments, the interior of the dietary strands remain substantially unbroken when the edible composition is chewed. In some embodiments, the flavored coating of the dietary strands disintegrates or dissolves in gastric fluid.

As noted above, the dietary strands, having their beneficial dietary payload, are coated with a relatively thin flavored coating. The purpose of this thin flavored coating is to impart an appealing taste or smell to the surface of the coated dietary strands, which are then combined, adhered together, braided or woven into larger forms (i.e., the edible compositions) that have tastes and smells that resemble the flavor and aroma of conventional foods, such as meat. In some embodiments, the edible compositions described herein mimic the flavor and aroma of conventional foods by coating a thin layer of flavoring onto the surface of the dietary strands. The thin layer of flavoring contacts taste buds and mimics the “target” flavor of the conventional food. Upon consumption by an animal, the edible composition provides the flavor of the flavored coating to the taste buds of the animal and substantially prevents the flavor of the dietary strands from contacting the taste buds of the animal.

As noted above, the dietary strands can be coated with a relatively thin flavored coating by dipping them into the flavored coating in a liquid state, doing vapor deposition of the flavored coating onto the dietary strands. In some embodiments, the flavored coating has a thickness or diameter that is less than 10%, 9%, 8%, 7%, 6%, 5%, 4%, 3%, 2%, 1%, or a range between and including any two of these values, relative to the thickness or diameter of the dietary strands. In some embodiments, the flavored coating has a mass that is less than 25%, 10%, 8%, 6%, 4%, 2%, 1%, 0.01%, or a range between and including any two of these values, relative to the mass of the dietary strands.

In some embodiments, the flavored coating is a single layer. In some embodiments, the single layer includes at least one of a sweetening agent, a food flavoring agent or enhancer, a food color, an odorant, an antimicrobial agent, an antioxidant, a surface modifying agent, a carbohydrate, or a mixture thereof. In some embodiments, the single layer is configured to disintegrate or dissolve in gastric fluid.

In some embodiments, the flavored coating includes two or more layers. The use of two or more layers can be used to separate the functionality of the flavored coating into an outer layer which provides taste or flavor and an inner layer which provides strength and gastric imperviousness. In an embodiment, the coating consists of an outer flavored coating and one or more inner barrier layers. In this embodiment the cross section of the dietary strand has three concentric regions. On the outside is a flavored coating designed to dominate the taste and flavor of the dietary strand. On the inside is the dietary payload. Separating and binding the outer layer to the interior payload is a barrier layer. This is designed to provide strength and gastric imperviousness, protecting the interior payload and isolating the user from its taste or texture. From a taste standpoint, the barrier layer can taste good (naturally or via additives), bland, or be effectively tasteless. However, the barrier layer does not have a bad or offensive taste. The presence of a barrier layer can advantageously allow more freedom in designing the outer flavored coating; it can be permitted to dissolve or disintegrate within the gastric fluids, enhancing taste or flavor, without thereby exposing the user to the taste of the interior dietary payload.

Thus, in some embodiments, the flavored coating may include at least two layers, where the two layers include an outer layer and one or more inner barrier layers. In some embodiments, the outer layer includes at least one of a sweetening agent, a food flavoring agent or enhancer, a food color, an odorant, an antimicrobial agent, an antioxidant, a surface modifying agent, a carbohydrate, or a mixture thereof. In some embodiments, the outer layer is configured to disintegrate or dissolve in gastric fluid. In some embodiments, at least one barrier layer is configured to remain substantially unbroken when the edible composition is chewed. In some embodiments, at least one barrier layer is configured to break less easily than the interior of the dietary strands when the edible composition is chewed. In some embodiments, at least one barrier layer is configured to resist dissolution or disintegration in gastric fluid. In some embodiments, at least one barrier layer is configured to have substantially no flavor, a bland flavor, or a flavor that resembles a conventional food item.

In some embodiments, the flavored coating has a thickness that is less than 10% of the diameter of the dietary strands. In some embodiments, the flavored coating has a thickness that is less than 1% of the diameter of the dietary strands.

In some embodiments, the edible composition includes a single type of flavored coating. In some embodiments, the edible composition includes more than one type of flavored coatings. As used herein, the term “type of flavored coating” refers to the particular composition of a flavored coating (i.e., its flavor and formulation). For example, one type of flavored coating may include a particular percentage of a sweetening agent, food color, and an odorant. Another type of flavored coating may include a different percentage of the same sweetening agent, food color, and an odorant or it may include different additives all together. In some embodiments, the edible composition includes more than one type of flavored coating. For example, the edible composition may include 2, 5, 10, 20, 50, 100 or 1,000 types of flavored coatings, or a range between and including any two of these values.

In some embodiments, the flavored coating is coated onto the dietary strands by dipping the dietary strands into the flavored coating (e.g., liquid dipping). In some embodiments, the flavored coating is sprayed onto the dietary strands (e.g., vapor deposition). In some embodiments, the flavored coating is prilled onto the dietary strands (e.g., via prilling towers). The coating can be multi-layered. For example, an already-coated strand, braid, weave, cloth-like structure, or scaffold of dietary strands can be dipped into an additional solution of flavored coating (e.g., including additional, tastants, odorants, synthetic meat cells, etc.) to obtain an additional outer coating.

In some embodiments, the flavored coating further includes a propellant. The propellant may be heat activated at body temperatures to propel flavorants or odorants from the edible composition. In some embodiments, the propellant is solid at 25° C. and at least partially vaporizes above a threshold temperature. In some embodiments, the threshold temperature is about 37° C. In some embodiments, the flavored coating further includes an odorant to excite olfactory receptors. In some embodiments, the odorant is solid at 25° C. and least partially vaporizes above a threshold temperature. In some embodiments, the threshold temperature is about 37° C.

Thus, in some embodiments, the edible composition includes a single type of flavored coating. In some embodiments, the edible composition includes more than one type of flavored coatings. In some embodiments, the coating step is performed onto individual strands. In other embodiments, the coating step is performed onto assembled braids or scaffolds of strands or after the strands have been woven into a cloth-like structure.

In some embodiments, the flavored coating is substantially insoluble in saliva. In some embodiments, the flavored coating is substantially soluble in gastric fluid.

In some embodiments, the flavored coating includes, but is not limited to, a sweetening agent, a food flavoring agent or enhancer, a food color, an odorant, an antimicrobial agent, an antioxidant, a surface modifying agent, a carbohydrate, an emulsification agent or a mixture thereof.

Examples of sweetening agents include, natural sweeteners, such as a sugar, and artificial sweetening products such as saccharin, cyclamate, monellin, thaumatins, curculin, miraculin, stevioside, phyllodulcin, glycyrrhizin, nitroanilines, dihydrochalcones, dulcin, suosan, guanidines, oximes, oxathiazinone dioxides, aspartame, alitame, and the like. Natural sweeteners can also be monosaccharides and oligosaccharides. Examples of monosaccharides include, but are not limited to, galactose, fructose, glucose, sorbose, agatose, tagatose and xylose. Examples of oligosaccharides include sucrose, lactose, lactulose, maltose, isomaltose, maltulose, saccharose and trehalose. Other sweetening agents that can also be used include, but are not limited to, high fructose corn syrup or sugar alcohols.

Examples of food flavoring agents or enhancers include, but are not limited to, monosodium glutamate, maltol, 5′-mononucleotides, such as inosine, and the like.

Examples of food colors include, but are not limited to, tartrazine, riboflavin, curcumin, zeaxanthin, (3-carotene, bixin, lycopene, canthaxanthin, astaxanthin, |3-apo-8′carotenal, carmoisine, amaranth, Ponceau 4R (E124), Carmine (E120), anthocyanidin, erythrosine, Red 2G, Indigo Carmine (E 132), Patent Blue V (E 131), Brilliant blue, chlorophyll, chlorophyllin copper complex, Green S (E142), Black BN (E151), and the like.

Examples of odorants include, but are not limited to, carbonyl compounds, pyranones, furanones, thiols, thioethers, di- and trisulfides, thiophenes, thiazoles, pyrroles, pyridines, pyrazines, phenols, alcohols, hydrocarbons, esters, lactones, terpenes, volatile sulfur compounds and the like.

Examples of antimicrobial agents include, but are not limited to, benzoic acid, PHB esters, sorbic acid, propionic acid, acetic acid, sodium sulfite and sodium metabisulfite, diethyl pyrocarbonate, ethylene oxide, propylene oxide, nitrite, nitrate, antibiotics, diphenyl, o-phenylphenol, thiabendazole and the like.

Examples of antioxidant agents include, but are not limited to, tocopherols, 2,6-di-tert-butyl-p-cresol (BHT), tert-butyl-4-hydroxyanisole (BHA), propylgallate, octylgallate, dodecylgallate, ethoxyquin, ascorbyl palmitate, ascorbic acid and the like.

Examples of surface modifying agents include, but are not limited to, mono-, diaglycerides and derivatives, sugar esters, sorbitan fatty acid esters, polyoxyethylene sorbitan esters, stearyl-2-lactylate and the like.

In some embodiments, the edible composition further includes a binding agent. In some embodiments, the binding agent is used to adhere dietary strands, braids or strands, scaffolds of strands, or weaves of strands together within the edible composition. The binding agent can be used to tune the ease or difficulty with which the dietary strands separate (e.g., “unbraid” and “unweave”) from one another during chewing. Thus, for example, excessive binding agent can be used to make an edible composition having dietary strands, braids, or weaves that are resistant to separation upon chewing. Little or no binding agent can be used to make an edible composition in which the dietary strands, braids, or weaves more readily separate from one another upon chewing. The binding agent can be distributed consistently or inconsistently throughout the edible composition. A consistent distribution of binding material throughout the edible composition generally permits the edible composition, and the dietary strands therein, to separate in a relatively uniform manner upon chewing. An inconsistent distribution of binding material at some portions of the edible composition relative to other portions generally permits the edible composition, and the dietary strands therein, to separate in a relatively uneven manner upon chewing. An inconsistent distribution of binding material can be used, for example, to allow portions of the edible composition to separate in stages relative to other portions. Such edible compositions that separate in stages in can be used to mimic complex foods with multiple textures. In some embodiments, the binding material is concentrated at points where dietary strands contact one another.

In some embodiments, the binding agent fails (e.g., by ceasing to adhere the dietary strands together) when the binding agent contacts saliva. In some embodiments, the binding agent fails above a threshold stress level, such as upon chewing. In some embodiments, the binding agent fails above a threshold temperature, such as 25° C., 26° C., 27° C., 28° C., 29° C., 30° C., 31° C., 32° C., 33° C., 34° C., 35° C., 36° C., 37° C., 38° C., 39° C., or 40° C.

Non-limiting examples of suitable binding agents include guar gum, locust bean gum, carrageenan gum, pectin, gum arabic, gum acacia, agar, cellulose, cellulose derivatives, cornstarch, potato starch, wheat starch, tapioca, agar, alginates, furcellaran, gum arabic, gum ghafti, gum tragacanth, karaya gum, tamarind flour, arabinogalactan, dextrins, hemicelluloses, xanthan gum, scleroglucan, dextran, and the like.

The edible composition include dietary strands and flavored coatings. The edible composition may further include other geometric forms such as “dietary granules,” “dietary cubes,” “dietary spheres,” “dietary sheets” that can be added to the dietary strands to augment the structure and texture of the edible compositions. The dietary granules, dietary cubes, dietary spheres, and dietary sheets have compositions that are the same as the dietary strands, but their geometries are different from the dietary strands. The dietary granules, dietary cubes, dietary spheres, and dietary sheets can be similarly coated with flavored coatings and added with the coated dietary strands to the edible compositions.

In some embodiments, the dietary granules, dietary cubes, dietary spheres, and dietary sheets and their flavored coatings have a diameter or thickness of about 1 μm, 10 μm, 100 μm, 1 mm, 10 mm, 100 cm, 1 cm, 2 cm, 3 cm or a range between and including any two of these values.

The dietary strands and flavored coatings can be adhered, braided, woven, molded, or shaped into three-dimensional structures that help control the texture of the edible compositions. For example, random dense-packing of dietary strands and flavored coatings is generally avoided because excessive packing can reduce the ability of the edible compositions to mimic conventional food textures. In some embodiments, the edible compositions described herein include arrangements of dietary strands and flavored coatings (e.g., braids, weaves, or scaffolds) that minimize randomized dense-packing. The net packing density of the dietary strands and flavored coatings can be controlled, for example, by shaping the dietary strands and flavored coatings into curved, kinked, angled, or spiraled strands. The strands or braids of strands can be arranged, for example, into approximate space-filling Peano curves that resist randomized dense packing Thus, the curvature or the extent of kinking or spiraling in the dietary strands or braids of strands can be increased to reduce dense-packing Alternatively, the curvature or the extent of kinking or spiraling in the dietary strands or braids of strands can be reduced to increase dense-packing. In some embodiments, the dietary strands or braids of strands are arranged into a series of curved and/or kinked and/or spiraled strands having a variety, or a hierarchy, of spirals or curves that, when combined into edible compositions, mimic the overall density variations of food textures such as the texture of meat.

In some embodiments, the dietary strands can be coated with flavored coatings and optionally braided into rope-like braids or laced into weaves. In other embodiments, the dietary strands are first braided into rope-like braids or laced into weaves before the entire braid or weave of dietary strands is coated with flavored coatings. In some embodiments, dietary strands, or braids or weaves of dietary strands, are arranged into a series of curved and/or kinked and/or spiraled shapes having a variety, or a hierarchy, of spirals or curves that, when combined into edible compositions, assume a particular texture and mimic the overall density variations of food such as the texture of meat.

The dietary strands, or braids or weaves of dietary strands, can also be crosslinked or interwoven to further control the texture of the edible compositions. For example, the dietary strands, or braids or weaves of dietary strands, can be crosslinked to add lateral structure and additional texture to the edible compositions. Further, the dietary strands, or braids or weaves of dietary strands, can be woven or patterned as desired to provide different textures.

In some embodiments, dietary strands, or braids or weaves of dietary strands, resemble a three-dimensional space-filling pattern. For example, in some embodiments, the dietary strands, or braids or weaves of dietary strands, resemble a Peano curve. See FIG. 1. In some embodiments, the dietary strands (e.g., FIGS. 3A and 3B), or braids (e.g., FIGS. 3C and 3D), or weaves (e.g., FIG. 2) of dietary strands, resemble multiple Peano curves, having various space-filling properties. See FIGS. 5A and 5B. In some embodiments, the dietary strands, or braids or weaves of dietary strands, include more than one type of strand. In some embodiments, the dietary strands, or braids or weaves of dietary strands, knot up when cooked.

In some embodiments, the dietary strands, or braids or weaves of dietary strands, assemble into a scaffolding that supports, for example, less rigid (e.g., mushy) substances that mimic synthetic meats. Thus, in some embodiments, the dietary strands, or braids or weaves of dietary strands, form a scaffolding. Alternatively, this type of scaffold can be used as a framework for depositing and supporting artificially (e.g., in-vitro) grown meat cells or adding less rigid substances onto an existing scaffold of dietary strands or braids of dietary strands to obtain synthetic foods, such as imitation meats. In some embodiments, the edible composition further includes synthetic meat that is “grown” in-vitro onto the scaffolding of dietary strand, or braids or weaves of dietary strands. In other embodiments, the edible composition further includes synthetic meat that is added onto the scaffolding of dietary strand, or braids or weaves of dietary strands. In some embodiments, the synthetic meat does not spoil. For example, the synthetic meat will remain edible at 25° C. for at least six months, at least 1 year, at least 2 years, at least 5 years, or longer.

As noted, the dietary strands, or braids of dietary strands, can also be woven. The dietary strands or braids of dietary strands can be woven into a two-dimensional or three-dimensional cloth-like pattern with different hierarchies of structure, density, and/or stiffness, etc. Further, different types of dietary strands or braids of dietary strands can be woven together in desired ratios, patterns, and/or layers.

In some embodiments, the dietary strands are braided into an individual rope-like structure such as that shown in FIG. 3C. In some embodiments, more than one individual rope-like structures, such as that shown in FIG. 3C, are joined to form a plurality of rope-like structures. In some embodiments, the plurality of rope-like structures is joined by braiding or weaving together the individual rope-like structures. In some embodiments, the plurality of rope-like structures is joined by braiding or weaving additional dietary strands such as those shown in FIG. 3B, into a plurality of individual rope-like structures. In some embodiments, the plurality of rope-like structures is joined by an edible binder, such as starch. In some embodiments, the plurality of rope-like structures has at least one property that differs from its constituent individual rope-like structures. In some embodiments, the property is taste, appearance, or durability.

In some embodiments, the weave is configured so that the color of the dietary strands forms a distinct visual pattern. For example, a weave may be configured to form a particular color. In some embodiments, multiple weaves are combined and configured to resemble multiple visual patterns. For example, multiple weaves are combined and configured to form a particular food-like pattern such as the multicolor appearance of meat. In some embodiments, the distinct visual pattern or the multiple visual patterns resembles a conventional food. In some embodiments, the weave is configured so that the taste of the dietary strands forms a specified flavor such as beef fat. In some embodiments, multiple weaves are configured to resemble multiple specified flavors, such as beef fat and beef protein, to resemble the complex flavor of steak. In some embodiments, each specified flavor resembles the complex flavor of a conventional food.

Thus, in some embodiments, the dietary strands are laced into a weave pattern, where the weave pattern includes warp strands and weft (i.e., woof) strands. Further, entire braids of dietary strands can also be woven. Thus, in some embodiments, the entire braids of dietary strands are laced into a weave pattern, where the weave pattern includes warp braids and weft braids. The longitudinal strands or braids are called the warp strands and the lateral strands or braids are the weft (i.e., woof) strands.

In some embodiments, the properties of the warp strands and/or braids are the same as the properties of the weft strands and/or braids. In some embodiments, the properties of the warp strands and/or braids differ from the properties of the weft strands and/or braids. For example, the warp strands and/or braids may be designed to dissolve from the weave pattern upon contact with saliva in the mouth of the consumer. Alternatively, the weft strands and/or braids may be designed to impart a crunchy texture, whereas the warp strands and/or braids may be designed to impart a mushy feel. In some embodiments, the weave, or portions of the weave, knot up when cooked. In some embodiments, at least one warp strand includes a dietary strand having a homogenous composition. In some embodiments, the strands and/or braids break up in a homogenous fashion to impart a uniform texture to the edible composition. In some embodiments, at least one weft strand includes a dietary strand having a homogenous composition. In other embodiments, the strands and/or braids break up in a non-homogenous fashion to impart a non-uniform texture to the edible composition. In some embodiments, the weave includes at least one of a plain weave pattern, a satin weave pattern, and a twill weave pattern.

In some embodiments, the strands and/or braids are wavy. In some embodiments, the waviness of the strands and/or braids is in-plane, helical, or irregular. In some embodiments, the waviness of the strands contributes to the density, porosity, or texture of the edible composition.

The edible compositions and, in particular the dietary strands, can be produced according to methods that are commonly used to make imitation meat products. Currently, most imitation meat products are made by two basic processes, either strand spinning or thermoplastic extrusion. The strand spinning technique is an adaptation of the spun strand method of making synthetic strands utilized in the textile industry. In this method, the dietary strands are prepared from ingredients described herein, such as soy protein and/or cellulose, by forming a spinning dope from alkali-treated protein and extruding the dope through a perforated die or membrane into an aqueous precipitating bath, which contains an acid and a salt. The acid bath sets the strands, which are formed in the bath. The dietary strand may be bundled together and stretched to orient the molecular structure of the strands. For further details in regard to the strand spinning technique, see the basic U.S. Pat. No. 2,682,466, U.S. Pat. No. 2,730,448, and U.S. Pat. No. 2,730,447, which relate to spun strand imitation meats.

An additional method of forming imitation meat products from the dietary strands described herein includes thermoplastics extrusion, which is an adaptation of technology involved in making ready-to-eat cereal food products. The thermoplastic extrusion process involves preparing a mixture of, for example, protein, water, and/or other ingredients described herein, and thereafter feeding the mixture into a cooker-extruder where it is subjected to heat and pressure, and subsequently extruding the mixture. The extrudate expands as it enters into the atmosphere to form “meat-like” strands. For examples of patents describing the thermoplastic extrusion techniques in forming meat analogs, see U.S. Pat. No. 3,102,031 and U.S. Pat. No. 3,488,770.

After the dietary strands have been extruded they can be coated by conventional means (e.g., liquid dipping, vapor deposition, prilling via towers) with any of the flavored coatings described herein and combined with other coated dietary strands to form braids, weaves, or scaffolds. Alternatively, after the dietary strands have been extruded they can first be combined with other coated dietary strands to form braids, weaves, or scaffolds, and the braids, weaves, or scaffolds themselves can be coated with any of the flavored coatings described herein.

After the dietary strands have been coated and braided, the resulting strands, braids, weaves and/or scaffolds can be formed into suitable three-dimensional space-filling patterns (i.e., shapes), dried, fried, frozen, sterilized, heated, or otherwise treated arid thereafter packaged.

In some embodiments, the edible composition has a flavor and texture that resembles the flavor and texture of a conventional food such as meat, ground meat, seafood, poultry, a cereal food product, a baked good product, a health food product, dairy product, fruit, vegetable, bakery item, confection, pet food product, or animal feed.

Meat and ground meat refer to animal flesh that is eaten as food. As used herein, meat includes the flesh of mammalian species (pigs, cattle, lambs, etc.) raised and prepared for human consumption, in addition to fish and other seafood, poultry, and other animals.

A cereal food product is a food product derived from the processing of a cereal grain. A cereal grain includes any plant from the grass family that yields an edible grain (seed). The most popular grains are barley, corn, millet, oats, quinoa, rice, rye, sorghum, triticale, wheat and wild rice. Examples of a cereal food product include, but are not limited to, whole grain, crushed grain, grits, flour, bran, germ, breakfast cereals, extruded foods, pastas, and the like.

A baked good product includes any of the cereal food products mentioned above and has been baked or processed in a manner comparable to baking, i.e., to dry or harden by subjecting to heat. Examples of a baked good product include, but are not limited to, bread crumbs, baked snacks, mini-biscuits, mini-crackers, mini-cookies, and mini-pretzels.

A health food product is any food product that imparts a health benefit. Many oilseed-derived food products may be considered as health foods. There can be mentioned soybeans, flax seed, sesame seed, pumpkin seeds, sunflower seeds, or food products processed from these seeds or which are incorporated into foods, such as soy nuggets and soy nuts. In addition health food products include oilseed-derived food products, fruit-derived food products, such as fruit bits, dried berries, and the like.

A pet food product is a product intended to be fed to a pet such as a dog, cat, bird, reptile, fish, rodent and the like. These products can include the cereal and health food products above, as well as meat and meat byproducts, grass and hay products, including but not limited to alfalfa, timothy, oat or brome grass and the like.

Animal feed is a product intended to be fed to animals such as turkeys, chickens, cattle, horses, swine and the like. As with the pet foods above, these products can include cereal, meat and meat byproducts, and grass and hay products.

According to another aspect, the present technology includes a method of providing an animal with nourishment, including providing the animal with any one of the edible compositions described herein. In some embodiments, the animal is a human. In other embodiments, the animal is not a human such as a pet, livestock animal, or wild animal.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent compositions, apparatuses, and methods within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as ‘up to,’ ‘at least,’ ‘greater than,’ ‘less than,’ and the like, include the number recited and refer to ranges which can be subsequently broken down into subranges as discussed above. Finally, as will be understood by one skilled in the art, a range includes each individual member.

While certain embodiments have been illustrated and described, it should be understood that changes and modifications can be made therein in accordance with ordinary skill in the art without departing from the technology in its broader aspects as defined in the following claims.

1. An edible composition comprising: a plurality of dietary strands coated with a flavored coating;
wherein the interior of each dietary strand comprises a fat, protein, carbohydrate, or a combination thereof;
wherein the dietary strands are braided or woven together; and
wherein the flavor of the interior of the dietary strand is distinct from the flavor of the flavored coating.

2. The edible composition of claim 1, comprising a single type of dietary strand.

3. The edible composition of claim 1, comprising more than one type of dietary strand.

4. The edible composition of claim 1, wherein the flavored coating comprises a single type of flavored coating.

5. The edible composition of claim 1, wherein the flavored coating comprises more than one type of flavored coating.

6. The edible composition of claim 1, wherein the interior of the dietary strands comprises protein derived from soy, whey, tofu, or a combination thereof.

7. The edible composition of claim 1, wherein the interior of the dietary strands comprises an edible form of cellulose.

8. The edible composition of claim 1, wherein the dietary strands further comprise a vitamin or nutrient.

9. The edible composition of claim 1, wherein the diameter of the dietary strands is in the range of about 1 μm to about 1 mm.

10. (canceled)

11. The edible composition of claim 1, wherein the interior of the dietary strands is substantially insoluble in saliva.

12. The edible composition of claim 1, wherein the interior of the dietary strands remains substantially unbroken when the edible composition is chewed.

13. The edible composition of claim 1, wherein the dietary strand comprises a plurality of longitudinal dietary strands longitudinally interconnected by linkages.

14. The edible composition of claim 13, wherein the linkages have a homogenous edible composition.

15. The edible composition of claim 13, wherein the linkages dissipate during eating and separate the dietary strands into their longitudinal segments.

16. The edible composition of claim 13, wherein each of the longitudinal dietary strands has a length to diameter ratio of greater than 10.

17. The edible composition of claim 13, wherein the ratio of the average length of the linkages to the average length of the longitudinal dietary strands is less than 0.05.

18. The edible composition of claim 13, wherein the interior of the longitudinal dietary strands remains substantially unbroken when the edible composition is chewed.

19. The edible composition of claim 13, wherein the linkages are configured to break more easily than the longitudinal dietary strands when the edible composition is chewed.

20. The edible composition of claim 13, wherein the linkages are configured to disintegrate or dissolve in gastric fluid more easily than the longitudinal dietary strands when the edible composition is consumed.

21. The edible composition of claim 1, wherein at least a portion of the flavored coating is configured to disintegrate or dissolve in gastric fluid.

22. The edible composition of claim 1, wherein the flavored coating has a single layer.

23. The edible composition of claim 22, wherein the single layer comprises at least one of a sweetening agent, a food flavoring agent or enhancer, a food color, an odorant, an antimicrobial agent, an antioxidant, a surface modifying agent, a carbohydrate, or a mixture thereof.

24. The edible composition of claim 22, wherein the single layer is configured to disintegrate or dissolve in gastric fluid.

25. The edible composition of claim 1, wherein the flavored coating comprises at least two layers, and wherein the two layers comprise an outer layer and one or more inner barrier layers.

26. The edible composition of claim 25, wherein the outer layer comprises at least one of a sweetening agent, a food flavoring agent or enhancer, a food color, an odorant, an antimicrobial agent, an antioxidant, a surface modifying agent, a carbohydrate, or a mixture thereof.

27. The edible composition of claim 25, wherein the outer layer is configured to disintegrate or dissolve in gastric fluid.

28. The edible composition of claim 25, wherein at least one barrier layer is configured to remain substantially unbroken when the edible composition is chewed.

29. The edible composition of claim 25, wherein at least one barrier layer is configured to break less easily than the interior of the dietary strands when the edible composition is chewed.

30. The edible composition of claim 25, wherein at least one barrier layer is configured to resist dissolution or disintegration in gastric fluid.

31. The edible composition of claim 25, wherein at least one barrier layer is configured to have substantially no flavor, a bland flavor, or a flavor that resembles a conventional food item.

32. The edible composition of claim 1, wherein the flavored coating has a thickness that is less than 10% of the diameter of the dietary strands.

33. The edible composition of claim 1, wherein the flavored coating has a thickness that is less than 1% of the diameter of the dietary strands.

34. The edible composition of claim 1, wherein the flavored coating has a mass that is less than 10% of the mass of the dietary strands.

35. The edible composition of claim 1, wherein the flavored coating has a flavor that resembles the flavor of a conventional food item.

36. The edible composition of claim 35, wherein the conventional food item is a meat, dairy product, fruit, vegetable, bakery item, or confection.

37.-47. (canceled)

48. The edible composition of claim 1, wherein the dietary strands are braided.

49. The edible composition of claim 48, wherein the braided dietary strands form a scaffolding.

50.-68. (canceled)

69. The edible composition of claim 1, wherein the dietary strands are braided into an individual rope-like structure.

70. The edible composition of claim 69, wherein more than one individual rope-like structures are joined to form a plurality of rope-like structures.

71. The edible composition of claim 70, wherein the plurality of rope-like structures is joined by braiding or weaving together the individual rope-like structures.

72. The edible composition of claim 70, wherein the plurality of rope-like structures is joined by braiding or weaving additional dietary strands into the plurality of individual rope-like structures.

73. The edible composition of claim 70, wherein the plurality of rope-like structures is joined by an edible binder.

74. The edible composition of claim 70, wherein the plurality of rope-like structures has at least one property that differs from its constituent individual rope-like structures.

75. The edible composition of claim 74, wherein the property is taste, appearance, or durability.

76. The edible composition of claim 1, wherein the dietary strands are wavy.

77. The edible composition of claim 76, wherein the waviness of the dietary strands is in-plane, helical, or irregular.

78. The edible composition of claim 76, wherein the waviness of the dietary strands contributes to the density, porosity, or texture of the edible composition.

79.-81. (canceled)
